(19) United States
(12) Patent Application Publication
(10) Pub. No.: US 2024/0040408 A1
(43) Pub. Date: Feb. 1, 2024

(54) MOBILE TERMINAL TESTING DEVICE AND MCS SET VALUE SEARCHING METHOD THEREFOR

(71) Applicant: ANRITSU CORPORATION, Kanagawa (JP)

(72) Inventor: Takahiro HOSOYA, Kanagawa (JP)

(21) Appl. No.: 18/296,053

(22) Filed: Apr. 5, 2023

(30) Foreign Application Priority Data
Jul. 28, 2022 (JP) 2022-120743

(51) Int. Cl. H04W 24/06

(52) U.S. Cl. CPC H04W 24/06

(57) ABSTRACT

Provided is a mobile terminal testing device that can improve efficiency of test by automatically searching for a set value that satisfies a predetermined condition according to a set parameter. A mobile terminal testing device includes: a pseudo base station unit 2 that transmits and receives an RF signal to and from a mobile terminal 10; a scenario processing unit 3 that causes the pseudo base station unit 2 to transmit notification information or to execute a communication sequence with the mobile terminal 10, based on a scenario of a test; and a control unit 6 that searches for and presents a set value of an MCS that satisfies a predetermined condition according to a parameter set to simulate a base station.

### TECHNICAL FIELD

The present invention relates to a mobile terminal testing device that performs a test of a mobile terminal.

### BACKGROUND ART

When a mobile terminal for performing communication while moving, such as a mobile phone or a data communication terminal, is developed, the developed mobile terminal needs to be tested whether or not communication can be normally performed. Therefore, a mobile terminal to be tested is connected to a testing device operated as a pseudo base station that simulates functions of an actual base station to perform communication between the testing device and the mobile terminal, and a test to confirm contents of the communication is performed.

As mobile communication systems, long term evolution (LTE), 5th generation (5G), new radio (NR), and the like are being served.

In the LTE, 5G, or NR, communication is performed by estimating a radio propagation path and determining modulation and coding scheme (MCS), the number of resource blocks (RBs) based on the estimated results.

Patent Document 1 discloses that a transport block size (TBS), which represents the number of bits of information that can be transmitted while satisfying a predetermined packet error rate over the entire bandwidth of a radio signal, is obtained from the MCS, the number of RBs, and a transmission mode, and a packet transmission rate is obtained from the obtained TBS and is displayed.

### RELATED ART DOCUMENT

### [Patent Document]

[Patent Document 1] Japanese Patent No. 5337843

### DISCLOSURE OF THE INVENTION

### Problem that the Invention is to Solve

In the mobile terminal testing device, parameters for simulating a base station need to be set according to contents of a test to be performed.

However, for example, the TBS is determined by values such as the number of RBs and the MCS, but many parameters need to be adjusted in order to set the TBS to a desired value.

Moreover, the 3rd generation partnership project (3GPP) standard requires a code rate, which is a rate of an amount of data to be transmitted to the maximum amount of data that can be transmitted to the terminal, of equal to or less than a standard value, and the parameters need to be adjusted so as to satisfy this condition.

For this reason, setting parameters for simulating a base station is troublesome, and the efficiency of test becomes poor.

Accordingly, an object of the present invention is to provide a mobile terminal testing device that can improve efficiency of test by automatically searching for a set value that satisfies a predetermined condition according to the set parameter.

### Means for Solving the Problem

A mobile terminal testing device of the present invention is for testing a mobile terminal by simulating a base station of a mobile communication, and the mobile terminal testing device includes: a control unit that searches for and presents a set value of an MCS that satisfies a predetermined condition according to a parameter set to simulate the base station.

With this configuration, the set value of the MCS that satisfies the predetermined condition is searched for and presented according to the set parameter. Therefore, it is possible to reduce the burden on a user and improve test efficiency.

In addition, in the mobile terminal testing device of the present invention, the control unit searches for the MCS having a code rate of equal to or less than a standard value and having a maximum TBS.

With this configuration, the MCS having the code rate of equal to or less than the standard value and the maximum TBS is searched for. Therefore, the MCS having the maximum TBS is automatically presented, so that it is possible to reduce the burden of the user and improve the test efficiency.

In addition, the mobile terminal testing device of the present invention further includes: a pseudo base station unit that transmits and receives an RF signal to and from the mobile terminal; a scenario processing unit that reads a stored scenario according to an instruction from the control unit and causes the pseudo base station unit to execute a communication sequence with the mobile terminal based on the scenario; an operation unit that outputs, to the control unit, information required to generate the scenario in which an operation is input; and a display unit that displays the set value of the MCS.

In addition, in the mobile terminal testing device of the present invention, the parameter includes at least a frame configuration, an antenna configuration, and a modulation scheme, and the MCS is searched for based on a table showing a relationship between the MCS and the TBS, which correspond to setting contents of the parameter stored in advance.

In addition, an MCS searching method of the present invention is a method for searching for a set value of an MCS of a mobile terminal testing device for testing a mobile terminal by simulating a base station of mobile communication, and the method includes: calculating a code rate based on a current MCS and a set parameter; calculating a TBS based on the current MCS and the set parameter when the calculated code rate is equal to or less than a standard value; setting the current MCS as a maximum value of the MCS and setting a value of a current TBS as a maximum value of the TBS, when the calculated TBS is greater than a current maximum value; and executing above steps on all MCSs to obtain an MCS having a maximum TBS.

With this configuration, the MCS having the code rate of equal to or less than the standard value and the maximum TBS is searched for. Therefore, the MCS having the maximum TBS is automatically presented, so that it is possible to reduce the burden of the user and improve the test efficiency.

### Advantage of the Invention

According to the present invention, it is possible to provide a mobile terminal testing device that can improve efficiency of test by automatically searching for a set value that satisfies a predetermined condition according to a set parameter.

### BRIEF DESCRIPTION OF THE DRAWINGS

FIG. 1 is a block diagram of main parts of a mobile terminal testing device according to one embodiment of the present invention.

FIG. 2 is a diagram showing a relationship between MCS and TBS when 256QAM is invalid as a modulation scheme of the mobile terminal testing device according to one embodiment of the present invention.

FIG. 3 is a diagram showing a relationship between MCS and TBS when 256QAM is valid as a modulation scheme of the mobile terminal testing device according to one embodiment of the present invention.

FIG. 4 is a flowchart explaining a procedure of MCS search processing of the mobile terminal testing device according to one embodiment of the present invention.

### BEST MODE FOR CARRYING OUT THE INVENTION

Hereinafter, a mobile terminal testing device according to an embodiment of the present invention will be described with reference to the drawings.

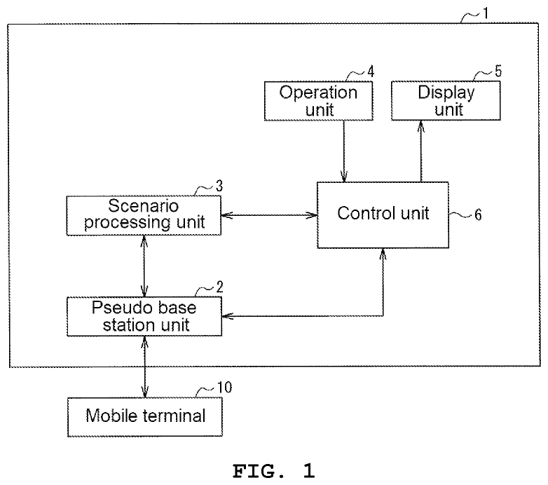

In FIG. 1, a mobile terminal testing device 1 according to one embodiment of the present invention transmits and receives a radio frequency (RF) signal to and from a mobile terminal 10 by wire via a coaxial cable or the like as a pseudo base station. The mobile terminal testing device 1 may wirelessly transmit and receive the RF signal to and from the mobile terminal 10 via an antenna.

The mobile terminal testing device 1 includes a pseudo base station unit 2, a scenario processing unit 3, an operation unit 4, a display unit 5, and a control unit 6.

The pseudo base station unit 2 transmits and receives the RF signal to and from the mobile terminal 10 under the control of the scenario processing unit 3. The pseudo base station unit 2 outputs a communication state with the mobile terminal 10 and the like to the control unit 6.

The pseudo base station unit 2 can perform LTE communication with the mobile terminal 10 according to the LTE standard. The pseudo base station unit 2 may perform 5GNR communication with the mobile terminal 10 according to the 5GNR standard.

The scenario processing unit 3 reads a stored scenario according to an instruction from the control unit 6, and causes the pseudo base station unit 2 to transmit the notification information based on the scenario or to execute communication sequence with the mobile terminal 10.

The operation unit 4 is composed of input devices such as a keyboard, a mouse, and a touch panel, and outputs, to the control unit 6, information and the like required to generate a scenario in which an operation is input. The display unit 5 is composed of an image display device such as a liquid crystal display, and displays an image for inputting information required to generate a scenario, an image showing a state during a test, or the like.

In accordance with the instruction input to the operation unit 4, the control unit 6 causes the display unit 5 to display a test scenario creation screen to input information required to generate a test scenario, or generates a test scenario based on the information input to the operation unit 4 in the test scenario creation screen. In addition, in accordance with the instruction input to the operation unit 4, the control unit 6 transmits the instruction to the scenario processing unit 3 to execute a test based on the test scenario stored in a storage device, or causes the display unit 5 to display the state during the test and the like based on the information such as a state of each layer transmitted from the scenario processing unit 3 or a communication state with the mobile terminal 10.

In this case, the mobile terminal testing device 1 is composed of a computer device (not shown) including a communication module for performing communication with the mobile terminal 10. The computer device includes a central processing unit (CPU), read only memory (ROM), random access memory (RAM), a storage device such as a hard disk device, an input/output port, and a touch panel (each of which is not shown in the drawings).

A program for causing the computer device to function as the mobile terminal testing device 1 is stored in the ROM and the hard disk device of the computer device. That is, the computer device functions as the mobile terminal testing device 1 by the CPU executing the program stored in the ROM using the RAM as a work area.

Thus, in the present embodiment, the scenario processing unit 3 and the control unit 6 are configured by the CPU, and the pseudo base station unit 2 is configured by the communication module.

When the mobile terminal testing device 1 tests the mobile terminal 10 supporting LTE or 5GNR, the control unit 6 sets a parameter or a signal sequence of the test to a user as a pseudo base station of LTE or 5GNR, and creates a test scenario to store the test scenario in the storage device.

The mobile terminal testing device 1 of the present embodiment automatically searches for a set value of an MCS that satisfies a predetermined condition according to the parameter as the set pseudo base station, and presents the set value of the MCS to the user.

For example, the control unit 6 searches for an MCS having a code rate of equal to or less than a standard value and the maximum value of TBS, and causes the display unit 5 to display the set value of the MCS on a parameter set screen.

The code rate is approximately obtained by (amount of data to be transmitted to terminal)/(maximum amount of data that can be placed on a downlink frame of LTE).

The numerator (amount of data to be transmitted to terminal) is determined by the TBS value and the like. The denominator (maximum amount of data that can be placed on a downlink frame of LTE) is determined by the number RBs of a physical downlink shared channel (PDSCH) in the frame, the modulation scheme, and the like.

Various physical channels exist in the downlink frame, such as a reference signal, a notification information signal, a synchronization signal, a physical downlink control channel (PDCCH), a physical control format indicator channel (PCFICH), a physical HARQ indicator channel (PHICH), and the like. The PDSCH can be assigned to a resource where these physical channels do not exist, and user data is transmitted by the PDSCH.

Since resource mapping of the physical channel differs depending on the frame configuration, antenna configuration (MIMO: Multi Input Multi Output), and the like, the value of the denominator varies depending on these parameters. In addition, since the number of bits of data that can be transmitted by each symbol of PDSCH changes depending on the modulation scheme, the value of the denominator also varies depending on the modulation scheme.

The control unit 6 calculates the code rate based on the set parameters for all of the MCS indices defined by the standard.

The control unit 6 obtains the TBS value for the MCS index having the code rate of equal to or less than the standard value, and causes the display unit 5 to display the MCS having the maximum value of TBS as a set value of an MCS on the parameter set screen. The MCS may not only be displayed, but may also be set as a set value of the parameter.

The value of TBS varies depending on a frequency bandwidth of the RF signal, the number of RBs, the modulation scheme, the MCS index, and the like.

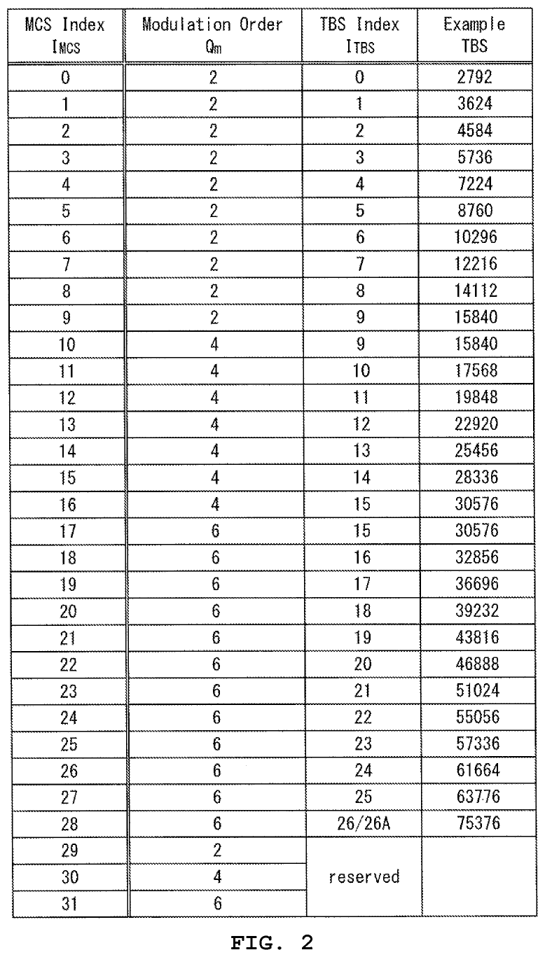

FIG. 2 is a table showing a relationship between an MCS index and a TBS value when a frequency bandwidth of the RF signal is 20 MHz, the number of RBs is 100, and 256QAM is invalid as a modulation scheme in a frequency division duplexing (FDD) scheme.

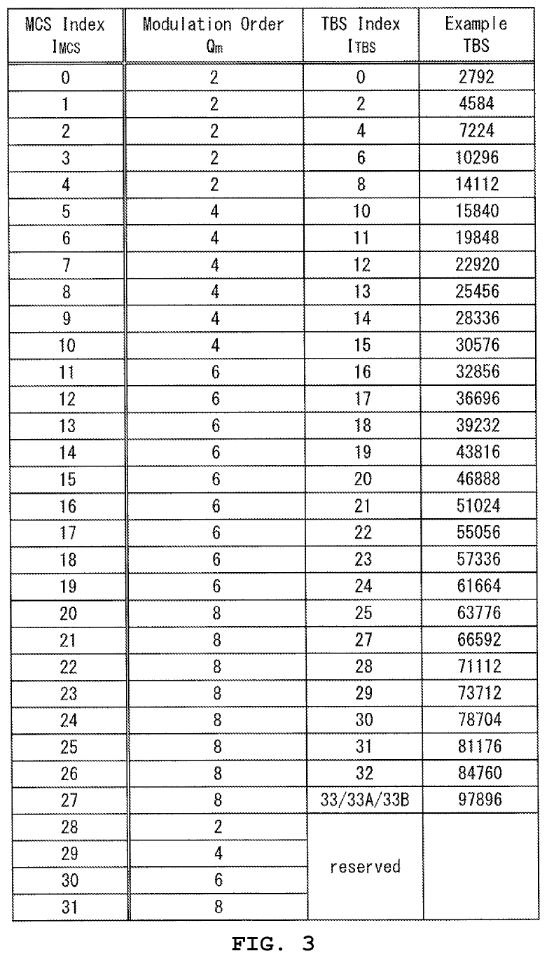

FIG. 3 is a table showing a relationship between an MCS index and a TBS value when 256QAM is valid as a modulation scheme under the same conditions as in FIG. 2.

As described above, in order to obtain an MCS having a code rate of equal to or less than the standard value and the maximum value of TBS, the MCS needs to be obtained by referring to setting contents of a plurality of parameters, resulting in a heavy burden on the user.

In the present embodiment, it is possible to reduce the burden on the user and improve test efficiency in order to automatically obtain the MCS, which has a code rate of equal to or less than the standard value and the maximum TBS value, to present the MCS to the user according to setting contents of the parameter.

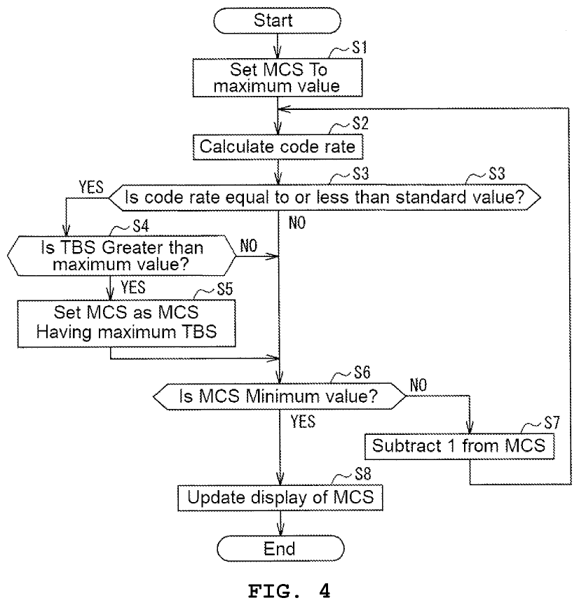

MCS search processing of the mobile terminal testing device 1 according to the present embodiment, which is configured as described above, will be described with reference to FIG. 4. The MCS search processing to be described below is started when an MCS setting function is selected by a user's operation of the operation unit 4.

In step S1, the control unit 6 sets an MCS index to the maximum value in a search range. After executing the process of step S1, the control unit 6 executes the process of step S2.

In step S2, the control unit 6 calculates a code rate based on the set MCS index and a set parameter. After executing the process of step S2, the control unit 6 executes the process of step S3.

In step S3, the control unit 6 determines whether or not the calculated code rate is equal to or less than the standard value.

When it is determined that the calculated code rate is equal to or less than the standard value, the control unit 6 executes the process of step S4. When it is determined that the calculated code rate is greater than the standard value, the control unit 6 executes the process of step S6.

In step S4, the control unit 6 calculates TBS based on the set MCS index and the set parameter, and determines whether or not the calculated TBS value is greater than the current maximum value.

When it is determined that the TBS value at the set MCS index is greater than the current maximum value, the control unit 6 executes the process of step S5. When it is determined that the TBS value at the set MCS index is equal to or less than the current maximum value, the control unit 6 executes the process of step S6.

In step S5, the control unit 6 sets the current MCS index as an MCS index having the maximum value of TBS, and sets the current TBS value as the maximum value of TBS. After executing the process of step S5, the control unit 6 executes the process of step S6.

In step S6, the control unit 6 determines whether or not the value of the MCS index is the minimum value in the search range.

When it is determined that the MCS index value is the minimum value in the search range, the control unit 6 executes the process of step S8. When it is determined that the MCS index value is not the minimum value in the search range, the control unit 6 executes the process of step S7.

In step S7, the control unit 6 subtracts 1 from the MCS index value. After executing the process of step S7, the control unit 6 executes the process of step S2.

In step S8, the control unit 6 updates the MCS index value having the set maximum TBS value as a set value of an MCS set value, and causes the display unit 5 to display the set value of the MCS. After executing the process of step S8, the control unit 6 ends the MCS search processing.

As described above, in the present embodiment, the control unit 6 automatically obtains the MCS, which has a code rate of equal to or less than the standard value and the maximum TBS value, based on an instruction of the user to present the MCS to the user, according to the setting contents of the parameter.

As a result, the TBS value is calculated while confirming the setting contents of the parameter, and the MCS having the maximum TBS value is thus automatically presented without searching for the MCS having the maximum TBS value, so that it is possible to reduce the burden on the user and improve test efficiency. In addition, if the presented MCS is automatically set as a set value of the parameter, it is possible to reduce a load on the user to set the MCS using the operation unit 4.

In the present embodiment, although the MCS having the maximum TBS is searched for from the maximum value to the minimum value in the search range of the MCS index value, the MCS may be searched for from the minimum value to the maximum value in the search range of the MCS index value.

Moreover, when a test using carrier aggregation is performed, settings for a plurality of component carriers may be collectively performed by the above-described processing, or may be individually performed for each component carrier.

Moreover, in the present embodiment, although the MCS having the maximum TBS is searched for, the MCS may be searched for such that other conditions are met.

Although the embodiment of the present invention has been disclosed, it is apparent that those skilled in the art could have made changes without departing from the scope of this invention. It is intended that any and all such modifications and equivalents are involved in the appended claims.

### DESCRIPTION OF REFERENCE NUMERALS AND SIGNS

1 Mobile terminal testing device
2 Pseudo base station unit
3 Scenario processing unit
4 Operation unit
5 Display unit
6 Control unit
10 Mobile terminal

What is claimed is:

1. A mobile terminal testing device for testing a mobile terminal by simulating a base station of a mobile communication, the mobile terminal testing device comprising:
a control unit that searches for and presents a set value of an MCS that satisfies a predetermined condition according to a parameter set to simulate the base station.

2. The mobile terminal testing device according to claim 1,
wherein the control unit searches for the MCS having a code rate of equal to or less than a standard value and having a maximum TBS.

3. The mobile terminal testing device according to claim 2, further comprising:
a pseudo base station unit that transmits and receives an RF signal to and from the mobile terminal;
a scenario processing unit that reads a stored scenario according to an instruction from the control unit and causes the pseudo base station unit to execute a communication sequence with the mobile terminal based on the scenario;
an operation unit that outputs, to the control unit, information required to generate the scenario in which an operation is input; and
a display unit that displays the set value of the MCS.

4. The mobile terminal testing device according to claim 2,
wherein the parameter includes at least a frame configuration, an antenna configuration, and a modulation scheme, and
the MCS is searched for based on a table showing a relationship between the MCS and the TBS, which correspond to setting contents of the parameter stored in advance.

5. A method for searching for a set value of an MCS of a mobile terminal testing device for testing a mobile terminal by simulating a base station of mobile communication, the method comprising:
calculating a code rate based on a current MCS and a set parameter;
calculating a TBS based on the current MCS and the set parameter when the calculated code rate is equal to or less than a standard value;
setting the current MCS as a maximum value of the MCS and setting a value of a current TBS as a maximum value of the TBS, when the calculated TBS is greater than a current maximum value; and
executing above steps on all MCSs to obtain an MCS having a maximum TBS.
